(19) United States
(12) Patent Application Publication
(10) Pub. No.: US 2005/0187732 A1
(43) Pub. Date: Aug. 25, 2005

(54) Method for displaying and/or modifying parameters of a measuring device and measuring device for carrying out the method

(75) Inventors: Winfried Rauer, Fischerbach (DE); Robert Laun, Breitenbachstrasse (DE)

Correspondence Address: Gary M. Nath;NATH & ASSOCIATES PLLC, 6th Floor, 1030 15th Street, N.W., Washington, DC, 20005-1503, US

(73) Assignee: VEGA GRIESHABER KG

(21) Appl. No.: 11/109,673

(22) Filed: Apr. 20, 2005

Related U.S. Application Data
(63) Continuation of application No. 09/793,390, filed on Feb. 27, 2001.

(30) Foreign Application Priority Data
Sep. 25, 2000 (DE) 100 47 321.0

(51) Int. Cl. G06F 15/00

(52) U.S. Cl. 702/127

(57) ABSTRACT

In order to simplify display and modification of parameters of a measuring device and make them uniform for different measuring devices, it is proposed to transfer from a memory on the measuring device to the operating unit, in addition to parameter values, representational data that defines the presentation of the parameter values on operating unit (5). An Internet browser, a word-processing program or a spreadsheet program is used at operating unit (5) to display and optionally modify the parameter values; the representational data is stored in the measuring device in a file with a format adapted to the program used.

The invention pertains to the field of configuring measuring devices with the aid of an operating unit separated from the measuring device. More precisely, it pertains to a method for displaying parameters that define the operating mode of a measuring device on the display field of an operating unit wherein the values of parameters stored at the measuring device are transferred to the operating unit and, optionally, values of parameters changed by the user are transferred back from the operating unit to the measuring device.

Modern measuring equipment and/or systems, particularly those in which electronic processing of measurement signals takes place, usually have the possibility of displaying parameters relevant to the operating mode of the measuring device or the system on a separate operating unit, particularly a PC and, if necessary, of setting new values for the parameters. A program that communicates with the measuring device via an interface is installed in the operating unit for that purpose. Usually, such operating programs are usable only specifically for the manufacturer of the measuring device and/or only for a certain type of measuring device. This results in a number of disadvantages to the user:
A user who wishes to parametrize measuring devices of different type and origin must master usage of a number of operating programs, the logical structure and appearance of which vary widely from one manufacturer to another and frequently even among different measuring devices of one manufacturer and are thus confusing to the user.
The necessity of parametrizing a number of measuring devices with one operating unit has the consequence that a number of operating programs must be installed on one operating unit. The installation process is time-consuming. Furthermore, many users are disinclined to install new programs on a securely functioning PC for fear that they may impair the stability of the PC. The multiple programs also occupy considerable storage space.
If the functionality of operating programs is expanded, perhaps by adding a parameter, then the operating program must be adapted or updated. Even when a new version of the measuring device with a modified internal structure comes onto the market, an adapted version of the operating program is frequently necessary. This results in costs to the manufacturer which are often quite considerable, because updated versions of operating programs must be provided, not only for the version being currently marketed, but also for older versions. Accordingly, the problem arises that the user of the measuring devices must pay close attention to receiving the respective version of an updated program that suits the given device so as not to endanger functionality by installing an incorrect program.

The problem of the invention is to specify a method of the initially mentioned type and a measuring device suitable for carrying out the method which make it possible to eliminate or at least alleviate the aforementioned problems.

In order to limit the installation effort and the memory consumption in the operating unit, it is proposed according to the invention to transfer from the measuring device to the operating unit, in addition to the parameters to be displayed, representational data as well, which define the form of representation for the parameter values on the operating unit. For displaying the parameters on the operating unit in such a case, and optionally, for modifications of the parameter values, one program, which can be uniform for a number of measuring devices and which is, in particular, independent of the meaning and number of parameters considered, is sufficient, since information in this regard is made available by the measuring device and thus no longer need be contained in the code of the operating program.

In order to limit the amount of data to be transferred to the operating unit, it is desirable for parts of the representational data, preferably data that is identical for a large number of measuring devices, to be contained in the operating program, so that only equipment-specific or modified data need be transferred. If no display program is present on the operating unit, it can be transferred from the measuring device to the operating unit before the display of parameters.

These sets of data are expediently transferred to the operating unit in a format independent of it, in order to enable display of parameters on computers with not necessarily compatible architectures without requiring the manufacturer to provide different operating programs for the various computer systems.

Preferred examples of such instructions are HTML or XML code, JAVA instructions, or Perl, Javascript, TCL or VB-script.

The use of a telephone and Internet connection for the transfer of parameters and representational data allows the use of widely disseminated, economical and well-tested interfaces for the communication between measuring device and operating unit.

According to a particularly preferred embodiment of the method, an Internet browser, a word-processing program or a spreadsheet program is used to display the parameter values or to process the representational data. In such a case, the parameters and their representational data can be stored in the form of an Internet page or a file in the format specific to the word-processing or spreadsheet program.

Transmission by wireless means permits comfortable access to parameters of a measuring device that may be located at an arbitrary, difficult-to-access position, for instance, in a production line.

The method is preferably employed not only for displaying but also for modifying parameters in that the operating unit receives new values for the parameters selected by a user and transfers them to the measuring device.

A device for carrying out the above-specified method is characterized by a memory for the representational data. The representational data stored there contains at least one of the following types of information:
display and/or input masks for parameters to be displayed on the display field of the operating unit;
images for presenting information relating to the measuring device such as icons related to functions or function groups of the measuring device or representations of the measuring device or parts thereof which show a part of the measuring device influenced by a given parameter or the effects of modifying the parameter;
help information for using the measuring device in the form, for instance, of usage instructions that can be displayed on the display field.

The measuring device preferably comprises an interface converter and at least one measuring apparatus communicating with the interface converter, the interface converter serving to transfer the parameter values and the representational data to the operating unit. There is also preferably at least one part of the memory for representational data which is assigned to the interface converter. If no standard PC interface such as RS232 or USB is available on the measuring apparatus, the measuring device is preferably expanded with an interface converter that performs an adaptation of the physical interface and/or the transmission protocol of the measuring apparatus to a standard PC interface. At least one part of the memory for the representational data can also be assigned to the interface converter. Complete storage of the representational data at the interface converter is particularly practical when an already existing measuring device is to be made suitable for application of the method according to the invention by the addition of an adapted interface converter. A partial storage of the representational data at the interface converter is particularly practical for a measuring device comprising several measuring apparatuses, so as to store there those parts of the representational data which are not specific to a single measuring apparatus, but can be used to display and possibly modify the parameters of several measuring apparatuses. Data specific to each of the individual measuring apparatuses of the measuring device is preferably stored in a separate memory assigned to each measuring apparatus.

In case several measuring apparatuses are connected to an interface converter, a selection as to which connected apparatus is to be parametrized can be made by way of the representational data stored in the interface converter. In particular, the memory assigned to each measuring apparatus can contain text data with explanations on the use of the measuring apparatuses.

Additional characteristics and advantages of the invention result from the description below of an embodiment with reference to the attached figure, which shows a measuring device according to the invention and a connected operating unit in a highly schematized manner.

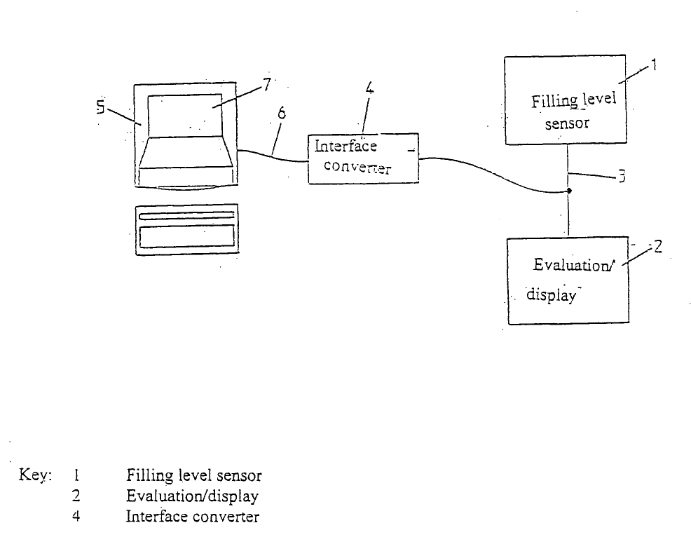

The measuring device shown as an example in FIG. 1 comprises as its measuring apparatus a fill level sensor, which is positioned on a container for a fluid or a bulk material in order to monitor its contents. The fill level signal is transmitted for evaluation to an evaluation unit, which may, for instance, be a connected stored program controller, or to a display unit 2. The communication between the evaluation or display unit 2 and the measuring apparatus 1 could, for instance, be accomplished via an RS232 interface, a well-known field bus such as a Profibus (Profibus is a standardized field bus protocol from Siemens AG) or via another known interface 3.

If no suitable interface is available on the computer 5 acting as the operating unit, an interface converter 4, which performs a conversion of the data exchanged on the transmission link into a format suitable for the operating unit 5, is used. The transmission link 6 between interface converter 4 and computer 5 may be a simple cable for serial data transfer, but it can also comprise a telephone connection or, at least in parts, a wireless link, the conversion into a format suitable for wireless transmission or transmission over a telephone connection taking place transparently (by way of modems, not shown).

In addition to memory space for the values of its parameters, the filling level sensor 1 is equipped with memory space for data that describes the representation of the parameter values on display screen 7 of computer 5. This representational information has the from of, for instance, an Internet site, i.e., a file in HTML format, as one example. In order to display the values of the parameters on screen 7, it is therefore sufficient if computer 5 is equipped with an Internet browser which makes a connection to filling level sensor 1 by way of interface converter 4 and retrieves the current values and the associated representational data there. Interface converter 4 extracts the parameter values and the representational information from the data flows on field bus 3 and passes them on to computer 5 for display. The browser used there requires no knowledge of the device to be programmed to display, based on the extracted representational data, a display and input mask adapted to filling level sensor 1 on screen 7, to receive, if desired, new values for selected parameters from the user and transmit them back to sensor 1. Since all the data required for displaying and editing the parameters is present in the sensor, computer 5 no longer requires a program tailored specifically to the programming of sensor 1.

Text data that explains the use of the measuring device or its parametrization is expediently also contained in the representational data. This text data can also be represented on screen 7 as part of the input mask or displayed to a user in response to the appropriate input as general or context-sensitive help text.

In order to update the operation of filling level sensor 1, it suffices in the system from FIG. 1 to update the representational data of sensor 1. This can be done, for instance, by exchanging a memory component such as an EPROM or by overwriting the data in an electrically rewritable memory such as an EEPROM in which this representational data is stored in sensor 1.

It goes without saying that the measuring device can also contain additional measuring apparatuses besides filling level sensor 1 and its controller 2, likewise connected to the field bus 3 and not shown in the figure. A memory element that contains the data necessary for parametrization of the measuring apparatus is assigned to each of these measuring apparatuses.

If the controller of one of these measuring apparatuses is to be modified, then it suffices to exchange the representational data in the associated memory. The modification is thus limited only to the memory assigned to a measuring apparatus; no updating of an entire measuring program is required. The modification can be done, for instance, by exchanging a memory component in which the representational data is stored; it is also conceivable to overwrite the representational data in each case with a new version from computer 5. Differently from the previous situation, no exchange of the operating program of the computer is necessary; it suffices merely to adapt the representational data of a measuring apparatus affected by a modification.

Particularly if the transmission link 6 comprises a telephone connection or some other stage leading through a public network, there is also the possibility for the manufacturer of the measuring apparatus or a service firm authorized by it to perform the update of the representational data, with the consent of the user, by remote maintenance via the public network.

In order to permit targeted programming of the parameters of one apparatus from a measuring device comprising several measuring apparatuses, the memory area which contains the representational data of a measuring apparatus is assigned a respective name, with which computer 5 is able to address the pertinent memory area.

Alternatively, it may be provided that interface converter 4 also has a memory element, in which a mask for selecting between the various measuring apparatuses is stored. Like the representational data of the apparatus itself, this mask is an HTML file.

In place of an Internet browser a spreadsheet or word-processing program can also be used to present an editable mask with the parameter values of the measuring device, since such programs are also frequently marketed by one manufacturer on a number of different platforms and offer an easy opportunity for modifying displayed parameter values by overwriting and saving cells or text passages.

1. Method for displaying parameters of a measuring device (1) on a display field (7) of an operating unit (5), in which values of the parameters stored at the measuring device are transferred to the operating unit (5), characterized in that, in addition to the parameter values, representational data which defines the form of representation of the parameter values on display field (7) is transferred to the operating unit (5).

2. Method according to claim 1, characterized in that the representational data comprises instructions to be executed by operating unit (5).

3. Method according to claim 2, characterized in that the instructions are transferred to operating unit (5) in a format independent of the operating unit.

4. Method according to claim 3, characterized in that the instructions comprise HTML or XML code or Java instructions.

5. Method according to one of the preceding claims, characterized in that the transfer is done with the aid of a telephone or Internet connection.

6. Method according to one of the preceding claims, characterized in that an Internet browser, a word-processing program or a spreadsheet program is used to display the parameter values on operating unit (5).

7. Method according to one of the preceding claims, characterized in that the transmission is done wirelessly.

8. Method according to one of the preceding claims, characterized in that operating unit (5) receives new values of parameters selected by a user and transmits them to measuring device (1).

9. Measuring device (1) for carrying out the method according to one of the preceding claims, characterized by a memory for representational data.

10. Measuring device according to claim 9, characterized in that the representational data contains at least one of the following types of information:
display and/or input masks for parameters;
images for presenting information related to the measuring device;
help information for using the measuring device.

11. Measuring device according to claim 9 or 10, characterized in that it comprises an interface converter (4) and at least one measuring apparatus communicating with interface converter (4), interface converter (4) serving to transmit the parameter values and the representational data to operating unit (5).

12. Measuring device according to claim 11, characterized in that at least a part of the memory for representational data is assigned to the interface converter.

13. Measuring device according to one of claims 9-12, characterized in that a memory assigned to the measuring apparatus contains text data with instructions on the use of the measuring apparatus.

14. Measuring device according to claim 12, characterized in that a selection of the apparatus to be parametrized is made by the representational data or instructions transmitted by interface converter (4).

15. Measuring device according to claim 11, characterized in that interface converter (4) is connected to an ordinary field bus.
